(19) United States
(12) Patent Application Publication
(10) Pub. No.: US 2026/0319645 A1
(43) Pub. Date: Oct. 15, 2026

(54) METHOD, APPARATUS, DEVICE AND STORAGE MEDIUM FOR GENERATING MEDIA RESOURCE

(71) Applicant: Bytedance Technology Ltd., Grand Cayman (KY)

(72) Inventors: Xiaocheng TANG, Los Angeles, CA (US); Shiyuan LIU, Culver City, CA (US); Tingyin DING, Los Angeles, CA (US); Qi ZHANG, Culver City, CA (US); Peilin LI, Los Angeles, CA (US); Jonathan GUZI, Culver City, CA (US)

(21) Appl. No.: 19/643,629

(22) Filed: Apr. 9, 2026

(30) Foreign Application Priority Data
Apr. 10, 2025 (CN) 202510449442.2

(51) Int. Cl. G06F 3/04842; G06F 3/0482

(52) U.S. Cl. CPC G06F 3/04842; G06F 3/0482

(57) ABSTRACT

The disclosure provides a method, apparatus, device, and storage medium for generating a media resource. The method includes: presenting a set of resource templates in an interactive interface with a virtual object; sending second prompt information to the virtual object based on a selection of a first resource template from the set of resource templates, the second prompt information being determined based on first prompt information corresponding to the first resource template, and the first prompt information being generated based on a first interactive topic associated with a preset time period; and providing a media resource generated based on the second prompt information.

### CROSS REFERENCE

The present application claims priority to Chinese Patent Application No. 202510449442.2, filed on Apr. 10, 2025, entitled “METHOD, APPARATUS, DEVICE AND STORAGE MEDIUM FOR GENERATING MEDIA RESOURCE”, which is incorporated herein by reference in its entirety.

### FIELD

Example embodiments of the present disclosure generally relate to the field of computers, and in particular, to a method, an apparatus, a device, and a computer-readable storage medium for generating a media resource.

### BACKGROUND

With the development of computer technology, more and more users create and share media content through Internet platforms. In the process of media content creation, various types of media resources (for example, effects, filters, etc.) may assist users in creating richer media content and improving creation effect of the media content.

### SUMMARY

In a first aspect of the present disclosure, there is provided a method of generating a media resource. The method includes: presenting a set of resource templates in an interactive interface with a virtual object; sending second prompt information to the virtual object based on a selection of a first resource template from the set of resource templates, the second prompt information being determined based on first prompt information corresponding to the first resource template, and the first prompt information being generated based on a first interactive topic associated with a preset time period; and providing a media resource generated based on the second prompt information.

In a second aspect of the present disclosure, there is provided an apparatus for generating a media resource. The apparatus includes: a first presentation module configured to present a set of resource templates in an interactive interface with a virtual object; a sending module configured to send second prompt information to the virtual object based on a selection of a first resource template from the set of resource templates, the second prompt information being determined based on first prompt information corresponding to the first resource template, and the first prompt information being generated based on a first interactive topic associated with a preset time period; and a first provision module configured to provide a media resource generated based on the second prompt information.

In a third aspect of the present disclosure, there is provided an electronic device. The device includes at least one processor; and at least one memory coupled to the at least one processor and storing instructions for execution by the at least one processor, the instructions, when executed by the at least one processor, causing the device to perform the method of the first aspect.

In a fourth aspect of the present disclosure, there is provided a non-transitory computer-readable storage medium. The computer-readable storage medium stores a computer program executable by a processor to implement the method of the first aspect.

It should be understood that the content described in this section is not intended to limit the key features or important features of the embodiments of the present disclosure, nor is it intended to limit the scope of the present disclosure. Other features of the present disclosure will become easy to understand through the following description.

### BRIEF DESCRIPTION OF THE DRAWINGS

The above and other features, advantages, and aspects of the embodiments of the present disclosure will become more apparent in combination with the drawings and with reference to the following detailed description. In the drawings, the same or similar reference symbols refer to the same or similar elements, where:

FIG. 1 illustrates a schematic diagram of an example environment in which the embodiments according to the present disclosure may be implemented;

FIGS. 2A to 2G illustrate example interfaces according to some embodiments of the present disclosure;

FIG. 3 illustrates a schematic architecture diagram of an example process for generating a media resource according to some embodiments of the present disclosure;

FIG. 4 illustrates a timing flowchart of an example process for generating a media resource according to some embodiments of the present disclosure;

FIG. 5 illustrates a flowchart of an example process for generating a media resource according to some embodiments of the present disclosure;

FIG. 6 illustrates a schematic structural block diagram of an example apparatus for generating a media resource according to some embodiments of the present disclosure; and

FIG. 7 illustrates a block diagram of an electronic device capable of implementing multiple embodiments of the present disclosure.

### DETAILED DESCRIPTION OF EMBODIMENTS

The embodiments of the present disclosure will be described in more detail below with reference to the drawings. Although some embodiments of the present disclosure are shown in the drawings, it should be understood that the present disclosure may be implemented in various forms and should not be construed as being limited to the embodiments set forth herein. Instead, these embodiments are provided for a more thorough and complete understanding of the present disclosure. It should be understood that the drawings and embodiments of the present disclosure are only for exemplary purposes, and are not intended to limit the protection scope of the present disclosure.

It should be noted that the titles of any section/subsection provided herein are not restrictive. Various embodiments are described throughout this article, and any type of embodiment may be included under any section/subsection. In addition, the embodiments described in any section/subsection may be combined with any other embodiments described in the same section/subsection and/or different section/subsection in any manner.

In the description of the embodiments of the present disclosure, the term "include/comprise" and similar terms thereof should be understood as open-ended inclusions, that is, "include/comprise but not limited to". The term "based on" should be understood as "at least partially based on". The term "one embodiment" or "the embodiment" should be understood as "at least one embodiment". The term "some embodiments" should be understood as "at least some embodiments". Other explicit and implicit definitions may also be included below. The terms "first", "second", etc. may refer to different or same objects. Other explicit and implicit definitions may also be included below.

The embodiments of the present disclosure may involve user data, data acquisition and/or use, etc. These aspects all comply with corresponding laws, regulations, and related provisions. In the embodiments of the present disclosure, all data collection, acquisition, processing, machining, forwarding, use, etc. are performed on the premise that the user is aware and confirms. Accordingly, when implementing the various embodiments of the present disclosure, the user should be informed of the type, range of use, use scenarios, etc., of possible data or information involved, and the authorization of the user should be obtained, through appropriate means in accordance with relevant laws and regulations. The specific means of informing and/or authorizing may vary according to actual situations and application scenarios, and the scope of the present disclosure is not limited in this respect.

If the solutions in this specification and the embodiments involve personal information processing, the processing will be performed on the premise that there is a legal basis (for example, the consent of the personal information subject is obtained, or it is necessary to perform a contract, etc.), and the processing will only be performed within the scope of regulations or agreements. If a user refuses to process personal information other than the necessary information required for the basic functions, it will not affect the user's use of the basic functions.

As mentioned above, with the development of computer technology, more and more users create and share media content through Internet platforms. In the process of media content creation, various types of media resources (for example, effects, filters, etc.) may assist users in creating richer media content and improving creation effect of the media content. In order to further improve the creation effect, some applications or platforms also support users to create such media resources.

The embodiments of the present disclosure propose a solution for generating a media resource. According to this solution, a set of resource templates may be presented in an interactive interface with a virtual object. Further, second prompt information may be sent to the virtual object based on a selection of a first resource template from the set of resource templates, the second prompt information being determined based on first prompt information corresponding to the first resource template, and the first prompt information being generated based on a first interactive topic associated with a preset time period. Additionally, a media resource generated based on the second prompt information may be provided.

Based on this approach, the embodiments of the present disclosure can provide selectable resource templates, thereby improving the efficiency of generating the media resource. Moreover, the embodiments of the present disclosure generate the media resource by referring to the first resource template related to the first interactive topic, so that the generated media resource may be more related to the first interactive topic, thereby improving the quality of the generated media resource.

Therefore, the embodiments of the present disclosure can improve the efficiency of generating the media resource and improve the quality of the generated media resource.

Various example implementations of this solution will be described in detail below in further conjunction with the drawings.

### Example Environment

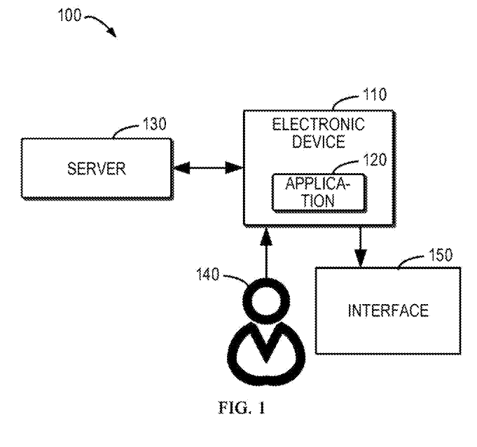

FIG. 1 illustrates a schematic diagram of an example environment 100 in which the embodiments of the present disclosure may be implemented. As shown in FIG. 1, the example environment 100 may include an electronic device 110.

In this example environment 100, the electronic device 110 may run an application 120 supporting generating a media resource. The application 120 may be any appropriate type of application for generating the media resource, examples of which may include but are not limited to a media application, a resource editing application, or other appropriate applications. A user 140 may interact with the application 120 via the electronic device 110 and/or its attached device.

In the environment 100 of FIG. 1, if the application 120 is active, the electronic device 110 may present an interface 150 for supporting generating the media resource through the application 120.

In some embodiments, the electronic device 110 communicates with a server 130 to implement the provision of services for the application 120. The electronic device 110 may be any type of mobile terminal, fixed terminal, or portable terminal, including a mobile phone, a desktop computer, a laptop computer, a notebook computer, a netbook computer, a tablet computer, a media computer, a multimedia tablet, a palmtop computer, a portable game terminal, a VR/AR device, a personal communication system (PCS) device, a personal navigation device, a personal digital assistant (PDA), an audio/video player, a digital camera/video camera, a positioning device, a TV receiver, a radio broadcast receiver, an e-book device, a game device, or any combination of the foregoing, including the fittings and peripherals of these devices or any combination thereof. In some embodiments, the electronic device 110 may also support any type of user-specific interface (such as "wearable" circuitry, etc.).

The server 130 may be an independent physical server, a server cluster or a distributed system composed of multiple physical servers, or a cloud server that provides basic cloud computing services such as cloud services, cloud databases, cloud computing, cloud functions, cloud storage, network services, cloud communications, middleware services, domain name services, security services, content delivery networks, and big data and artificial intelligence platforms. The server 130 may include, for example, a computing system/server, such as a mainframe, an edge computing node, a computing device in a cloud environment, and so on. The server 130 may provide back-end services for the application 120 that supports content presentation in the electronic device 110.

A communication connection may be established between the server 130 and the electronic device 110. The communication connection may be established in a wired or wireless manner. The communication connection may include but is not limited to a Bluetooth connection, a mobile network connection, a universal serial bus (USB) connection, a wireless fidelity (WiFi) connection, etc., and the embodiments of the present disclosure are not limited in this regard. In the embodiments of the present disclosure, the server 130 and the electronic device 110 may implement signaling interactive through the communication connection between the two.

It should be understood that the structure and function of each element in the environment 100 are described only for the purpose of illustration, without implying any limitation on the scope of the present disclosure.

Some example embodiments of the present disclosure will be described below with continued reference to the drawings.

### Example Interaction

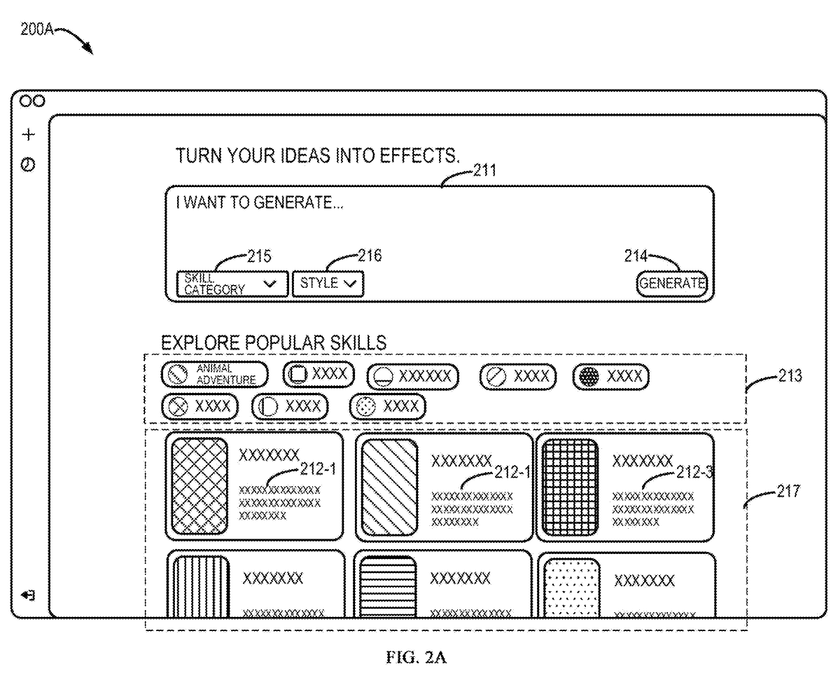

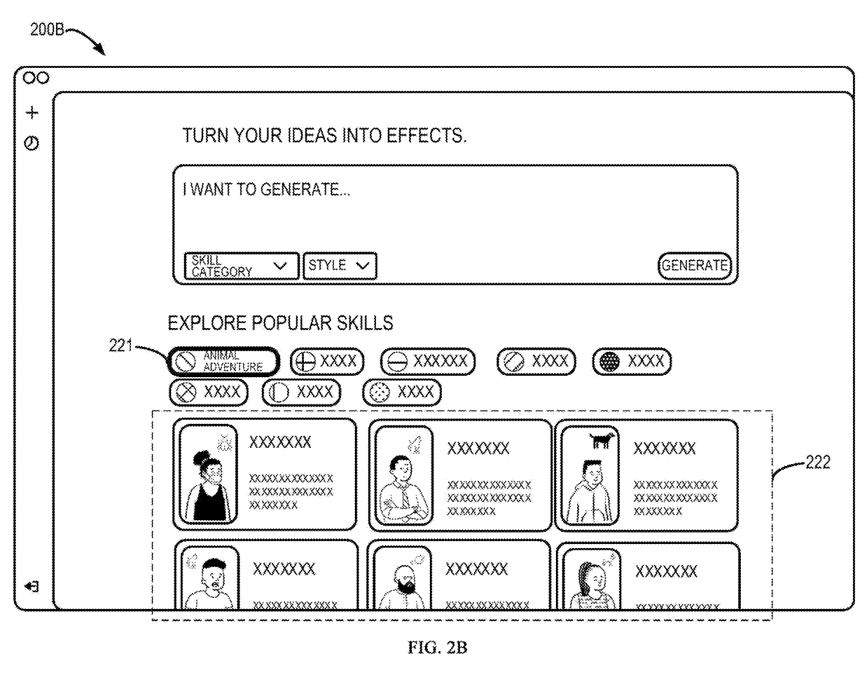

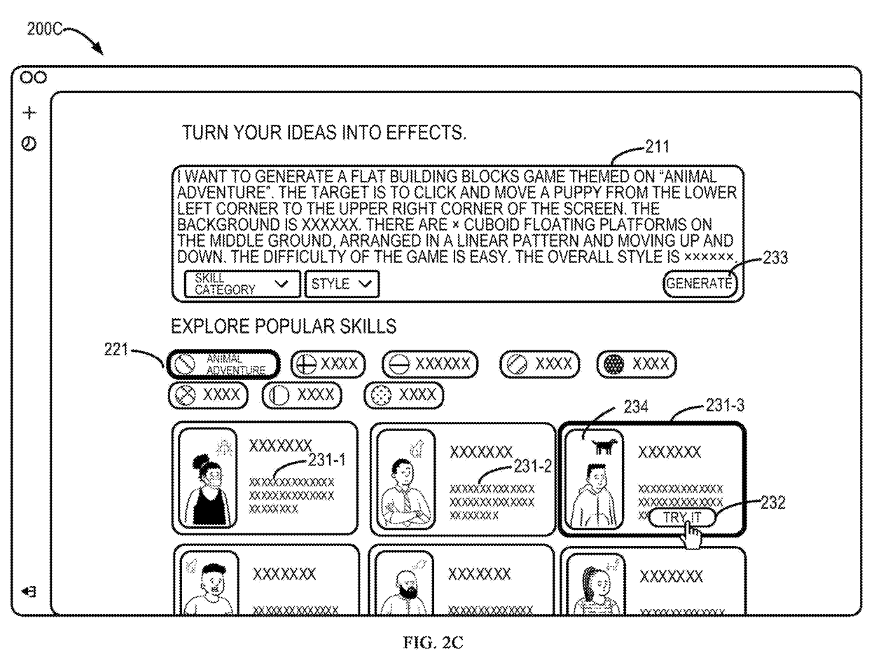

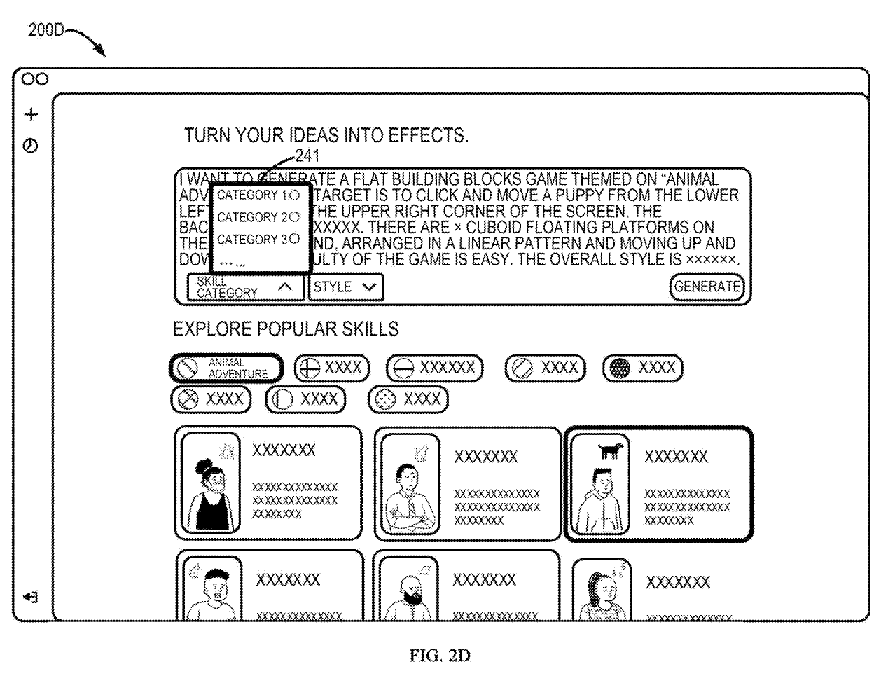

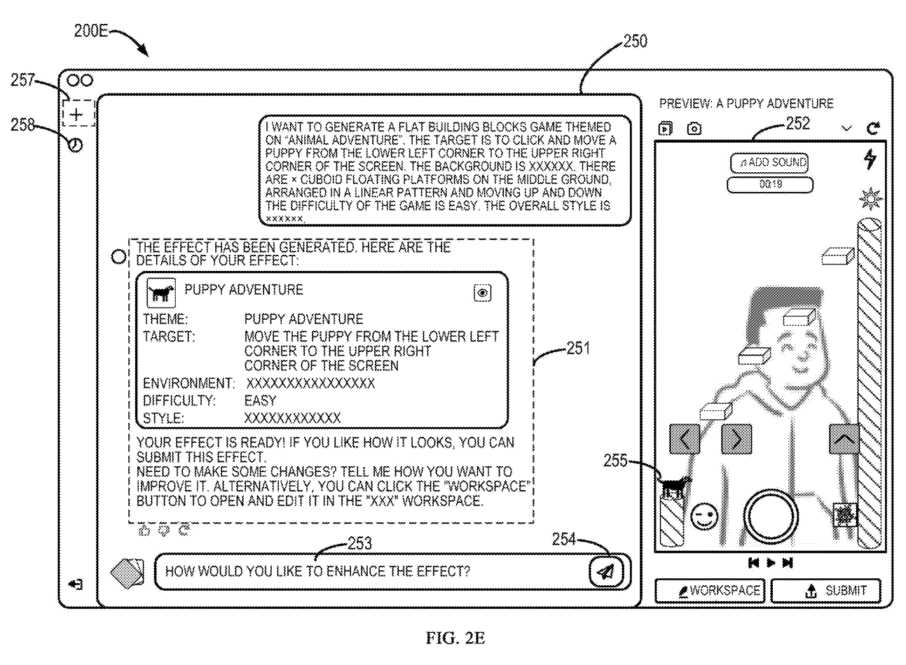

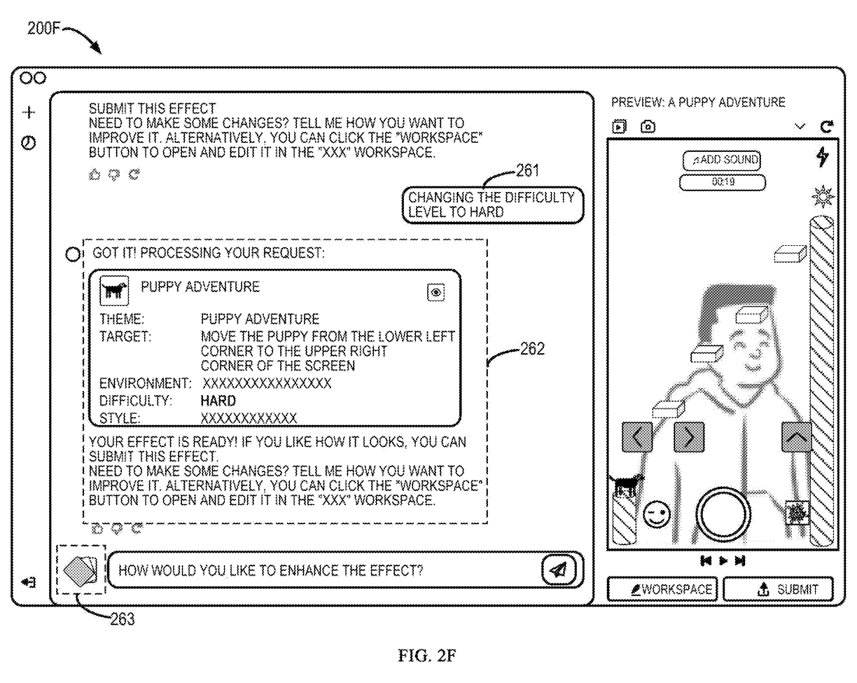

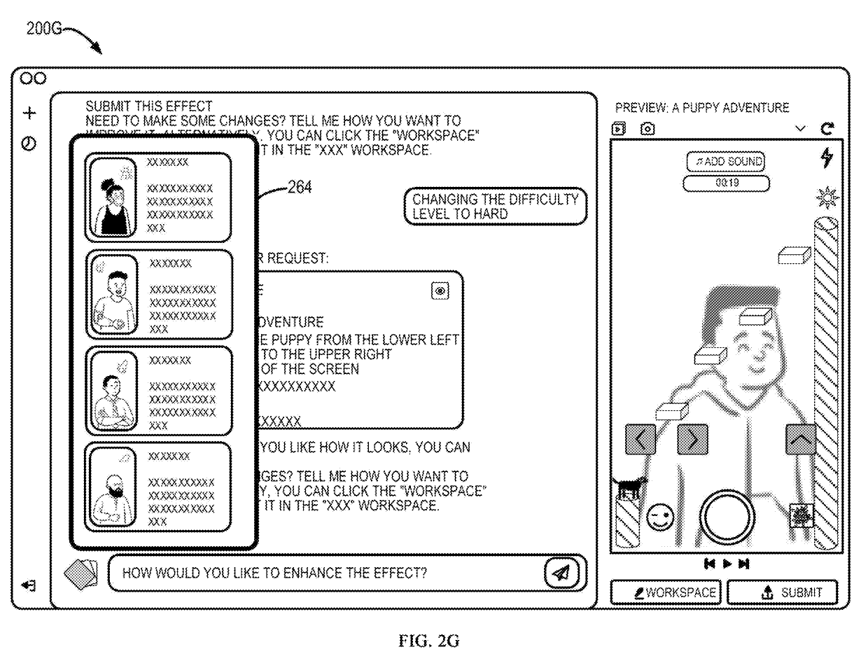

Some example interaction processes according to the embodiments of the present disclosure will be described below with reference to FIGS. 2A to 2G. FIGS. 2A to 2G illustrate example interfaces 200A to 200G according to some embodiments of the present disclosure, and the interfaces 200A to 200G may be provided, for example, by the electronic device 110 shown in FIG. 1.

In some embodiments, such interfaces 200A to 200G may include an interface for generating a media resource, and the user 140 may trigger generating the media resource by interacting with the preset interface. As an example, the user 140 may trigger generating the media resource by interacting with a virtual object, and therefore, such interfaces 200A to 200G may also include an interactive interface between the user 140 and the virtual object.

As an example, such a virtual object may include any appropriate processing entity that supports generating and/or editing a media resource through prompt information and the like. In some scenarios, the virtual object may also be referred to as a virtual entity, examples of which may include but are not limited to an agent, a machine program, or other processing entities that support triggering media resource editing through conversation. Such a virtual object may be implemented, for example, using an appropriate machine learning model to correspondingly generate and/or edit the media resource based on the received prompt information. The present disclosure is not intended to limit the specific construction manner of the virtual object.

As an example, the media resource may be used to create media content, examples of which include but are not limited to effects, filters, etc. For ease of understanding, the embodiments of the present disclosure exemplarily illustrate the present disclosure by using an effect as an example of the media resource. As an example, such media content includes but is not limited to images, videos, audios, and the like.

In some embodiments, according to the interface 200A shown in FIG. 2A, the electronic device 110 may present a component 211 in the interface 200A to support presenting prompt information for generating the media resource. As an example, such prompt information may be triggered to be input by the user 140. As an example, the user 140 may trigger inputting such prompt information into the component 211 in any appropriate manner, and the present disclosure is not intended to limit the specific form of information input by the user 140.

In some embodiments, the efficiency of generating the media resource based on the prompt information input by the user 140 is low. Therefore, the embodiments of the present disclosure may present a set of resource templates in the interface 200A. Further, the user 140 may select a specified resource template (marked as a first resource template for ease of distinction) from the set of resource templates to trigger sending second prompt information to the virtual object more quickly. Further, the electronic device 110 may provide to generate a corresponding media resource based on the second prompt information.

As an example, according to the interface 200A shown in FIG. 2A, the electronic device 110 may present a set of resource templates, which may include, for example, a template 212-1, a template 212-2, a template 212-3, etc. Further, the user 140 may trigger to select a first resource template from the set of resource templates to trigger sending second prompt information to the virtual object.

In order to improve the quality of the generated media resource, if the user 140 selects the first resource template, the electronic device 110 may also support the user 140 to preview, through the component 211 (also referred to as an input component), the prompt information that corresponds to the first resource template and that is used for generating the media resource. For example, the user 140 may trigger to present first prompt information corresponding to the first resource template in the component 211 by selecting the first resource template.

Further, the electronic device 110 may receive a sending operation associated with the component 211 to send the second prompt information to the virtual object. For example, such a sending operation may include a trigger operation of the user 140 for a control 214, and the user 140 may trigger the control 214 to trigger sending such second prompt information to the virtual object.

In some embodiments, such first prompt information may be used as the second prompt information. Alternatively, the user 140 may also trigger editing such first prompt information through the component 211 to improve the quality of the subsequently generated media resource. As an example, the user 140 may manually edit such first prompt information by adjusting the content of the first prompt information presented in the component 211.

Further, by editing such first prompt information, the electronic device 110 may determine second prompt information to use such second prompt information as target prompt information. Therefore, the user 140 may trigger the control 214 to send such second prompt information to the virtual object.

In some embodiments, such first prompt information may be generated based on a first interactive topic associated with a preset time period. For example, such first prompt information may be generated by the server 130 (or the electronic device 110), and the server 130 (or the electronic device 110) may generate the first prompt information based on the first interactive topic associated with the preset time period. As an example, for the process of generating such first prompt information, reference may be made to the example media resource generation process described below, and the embodiments of the present disclosure will not go into details here.

In some embodiments, historical interactive information corresponding to such first interactive topic may satisfy a preset condition. As an example, such historical interactive information may indicate an interactive situation of the first interactive topic within the preset time period, which may include, for example, public historical interactive information such as the number of comments and the number of views for the first interactive topic (or a creation associated with the first interactive topic, etc.). As an example, such a preset condition may indicate a high level of interaction. For example, such first interactive topic may also be referred to as a popular topic, and such preset condition may be set according to actual needs, and the present disclosure is not intended to limit the specific content and specific values of such preset condition. Therefore, the embodiments of the present disclosure may improve the quality of the generated first prompt information by interacting with more first interactive topics.

In some embodiments, the interface 200A may present a plurality of resource templates corresponding to a plurality of interactive topics to further improve the diversity of selectable resource templates. In order to improve the efficiency of generating the media resource, the interface 200A may present a set of candidate interactive topics to support the user to more quickly screen some resource templates corresponding to a specified candidate interactive topic.

As an example, according to the interface 200A shown in FIG. 2A, the electronic device 110 may present a set of candidate interactive topics in an area 213 of the interface 200A, and the user 140 may select the first interactive topic from the set of candidate interactive topics. Therefore, the electronic device 110 may present a set of resource templates corresponding to the first interactive topic in an area 217 for the user 140 to select from.

In some embodiments, if the user 140 does not select an interactive topic, the electronic device 110 may also present a plurality of resource templates in area 211 of the interface 200A, and the plurality of resource templates may correspond to the same or different candidate interactive topics in the set of candidate interactive topics.

As an example, at least a portion of the set of candidate interactive topics may be determined by the manner of determining the first interactive topic described above. As an example, the set of candidate interactive topics may also be determined by other means. For example, the set of candidate interactive topics may also include one or more preset candidate interactive topics, etc.

As an example, according to the interface 200B shown in FIG. 2B, the user 140 may select a topic 221 (for example, an "animal adventure" topic) from the set of candidate interactive topics, and the electronic device 110 may present a set of resource templates (for example, a template 231-1, a template 231-2, a template 231-3, etc.) corresponding to the topic 221 in an area 222 in the interface 200B. As an example, the electronic device 110 may further support the user 140 to view more resource templates corresponding to the topic 221 based on a slide operation of the user 140. Therefore, the user 140 may select the first resource template from the set of resource templates presented in area 222.

As an example, according to the interface 200C shown in FIG. 2C, such first resource template may include the template 231-3. Further, the user 140 may trigger a control 232 associated with the template 231-3 to trigger filling the component 211 with first prompt information corresponding to the template 231-3.

In some embodiments, the electronic device 110 may present reference media content corresponding to the first resource template in the interactive interface. For example, according to the interface 200C shown in FIG. 2C, the electronic device 110 may present reference media content 234 corresponding to the template 231-3. As an example, such reference media content 234 may be generated in advance. For example, the server 130 (or the electronic device 110) may generate a reference media resource based on the first resource template, and then generate the reference media content using the reference media resource. In this way, the user 140 may more conveniently understand the media effect of the resource template.

As an example, the specific generation of such reference media content may be implemented using any appropriate media application, and the present disclosure is not intended to limit the specific implementation of generating the reference media content. For example, for the specific implementation of generating the reference media content, reference may also be made to the specific implementation of generating a media resource based on the first resource template and generating corresponding media content based on the media resource, etc.

In some embodiments, still according to the interface 200A shown in FIG. 2A, the component 211 may also support quick adjustment of the input prompt text. As an example, such component 211 may include one or more option controls, and the user 140 may interact with the one or more option controls to trigger automatic editing of corresponding attributes of the first prompt information. For example, according to the interface 200A shown in FIG. 2A, the user 140 may trigger an option control 215 to adjust the category of the resource generation tool (also referred to as a skill or an ability, etc.) indicated by the first prompt information. As another example, the user may trigger an option control 216 to trigger adjustment of the theme of the first prompt information. As an example, the component 211 may also include other editing controls, and other attributes of the prompt information may be triggered to be edited accordingly, and the present disclosure is not intended to limit the type and function of such editing controls.

As an example, according to the interface 200D shown in FIG. 2D, when the user 140 triggers such option control 215, the electronic device 110 may present a corresponding window 241 to the user 140 to present a plurality of drop-down options (for example, category 1, category 2, category 3, etc.). Therefore, the user 140 may quickly select a specified category to quickly adjust the category of the resource generation tool corresponding to the prompt text.

Further, after providing the second prompt information to the virtual object, the electronic device 110 may provide a media resource generated based on the second prompt information. As an example, such a media resource may be provided through a chat between the user 140 and the virtual object.

As an example, according to the interface 200E shown in FIG. 2E, the electronic device 110 may present a chat window 250 with the virtual object, and present, in the chat window 250, a response message 251 generated by the virtual object based on the second prompt information, and the response message 251 may include the generated media resource and description information of the media resource. As an example, such description information may include the theme, the target, the environment, the level of difficulty, the style, etc., of the media resource.

For example, according to the interface 200E shown in FIG. 2E, such second prompt information may indicate the text content "I want to generate a flat building block game themed on “animal adventure”. The target is to click and move a puppy from the lower left corner to the upper right corner of the screen. The background is ××××××. There are × cuboid floating platforms on the middle ground, arranged in a linear pattern and moving up and down. The difficulty level of the game is easy. The overall style is ××××××". Further, the description information of the media resource generated based on the first prompt information may include "theme: a puppy adventure", "target: move the puppy from the lower left corner to the upper right corner of the screen", "difficulty: easy", etc. Therefore, the embodiments of the present disclosure can provide higher quality media resources more efficiently.

In some embodiments, the electronic device 110 may also present preview content of the media resource in the chat window to improve the efficiency of the user 140 in obtaining information about the media resource from the chat window. As an example, according to the interface 200E shown in FIG. 2E, such preview content may include the media content presented in a preview panel 252, and the media content may include the visual content corresponding to the media resource. For example, such visual content may include a puppy, an interactive platform, etc., in a picture. It should be understood that the specific content items (for example, the prompt information, the description information, the preview content, the visual elements, etc.) mentioned in the embodiments of the present disclosure are only exemplary, and the present disclosure is not intended to limit them.

In some embodiments, such first prompt information may include visual description information of at least one object associated with the first interactive topic, so that the media resource generated based on the first prompt information presents a visual element corresponding to the at least one object. For example, such first interactive topic may be "animal adventure", and such first prompt information may include visual description information associated with at least one object (for example, a puppy) associated with the "animal adventure". Therefore, such media resource may present a visual element (for example, an element 255, the element 255 indicating a puppy) corresponding to the at least one object.

In some embodiments, the user 140 may create a new chat by triggering an entry 257, and then re-send the prompt information to the virtual object. For example, when the user 140 triggers the entry 257, the electronic device 110 may be triggered to present the interface 200A shown in FIG. 2A. Further, the electronic device 110 may temporarily store the media resource generated in the current chat, and the user 140 may continue to edit the media resource subsequently. For example, the user 140 may trigger an entry 258 to view the temporarily stored media resource. Therefore, the embodiments of the present disclosure may further improve the efficiency of interactive between the user and the virtual object.

In some embodiments, the user 140 may further input prompt information through the input component to instruct the virtual object to further adjust the generated media resource. For example, the user 140 may input the prompt information indicating adjustment content by interacting with an input component 253, and send the prompt information by triggering a control 254. Further, the virtual object may adjust the generated media resource based on the prompt information.

For example, according to the interface 200F shown in FIG. 2F, the electronic device 110 may send a chat message 261 to indicate the prompt information of "changing the difficulty level to hard". Further, the electronic device 110 may present a response message 262 in the chat window, and the response message 262 may be generated by the virtual object based on the adjustment of the difficulty of the generated media resource.

In some embodiments, the electronic device 110 may support the user 140 to quickly switch resource templates through such a chat window to improve the efficiency of generating the media resource. For example, the user 140 may trigger a switching entry 263 to trigger presenting at least one candidate resource template. For example, according to the interface 200G shown in FIG. 2G, if the user 140 may trigger the switching entry 263, the electronic device 110 may present a window 264 and present the at least one candidate resource template in the window 264. Further, the user 140 may select a resource template to be switched (for example, a second resource template) from the presented at least one candidate resource template to trigger providing third prompt information corresponding to the resource template to be switched to the virtual object.

Based on this approach, the embodiments of the present disclosure can provide selectable resource templates, thereby improving the efficiency of generating the media resource. Moreover, the embodiments of the present disclosure generate the media resource by referring to the first resource template related to the first interactive topic, so that the generated media resource may be more related to the first interactive topic, thereby improving the quality of the generated media resource.

Therefore, the embodiments of the present disclosure can improve the efficiency of generating the media resource and improve the quality of the generated media resource.

### Example of Media Resource Generation Process

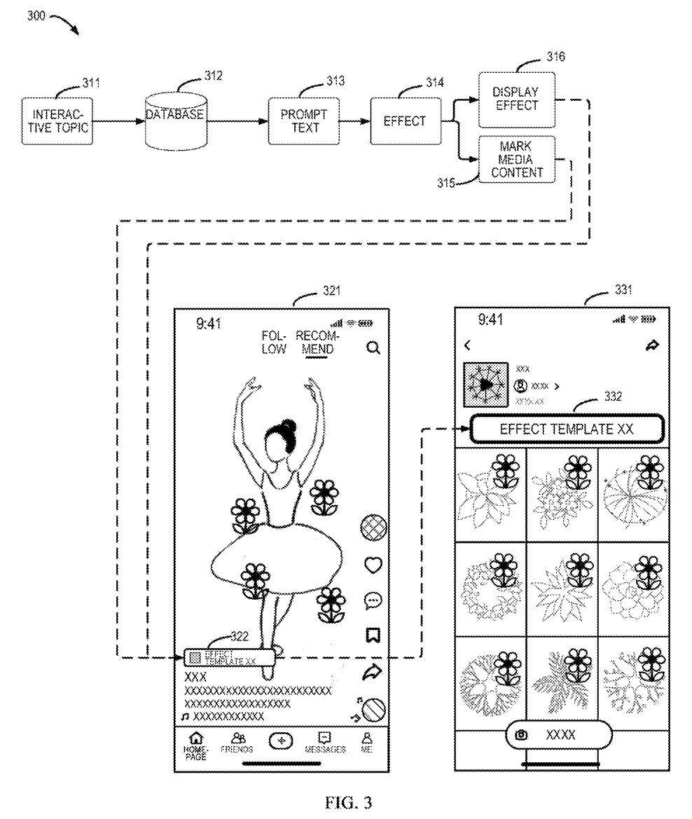

An example process of generating a resource template according to the embodiments of the present disclosure will be described below with reference to FIG. 3. FIG. 3 illustrates a schematic architecture diagram of a process 300 for generating a media resource according to some embodiments of the present disclosure, and the process 300 may be implemented as or included in the server 130. The process 300 is described below with reference to FIG. 1.

Taking the generation of a first resource template based on a first interactive topic as an example, as shown in FIG. 3, the server 130 may obtain the first interactive topic 311 and obtain a matching resource generation tool from a database 312 based on the first interactive topic 311. Further, the server 130 may use the first interactive topic 311 and the matching resource generation tool to generate first prompt information 211 to generate a corresponding media resource 314 (also referred to as an effect) based on the first prompt information 211.

In some embodiments, the server 130 may distribute the media content generated based on the effect and mark (315) the media content. As an example, such marking may be implemented through a label. For example, the viewing interface of the media content may include an interface 321, and a label associated with the first interactive topic may be presented in the interface 321. As an example, such a label may indicate the content of the first interactive topic or the information of the effect, and the present disclosure is not intended to limit the specific content items of the label.

In some embodiments, the server 130 may also display (316) the effect template in the media content. For example, the server 130 may present a control 322 associated with the media resource 314 in the interface 321. Therefore, the user 140 may trigger the control 322 to view a details page 331 of the media resource 314. Further, the details page 331 may present a creation entry 332 corresponding to the media resource 314 to support the user 140 to quickly apply the media resource 314 to create media content.

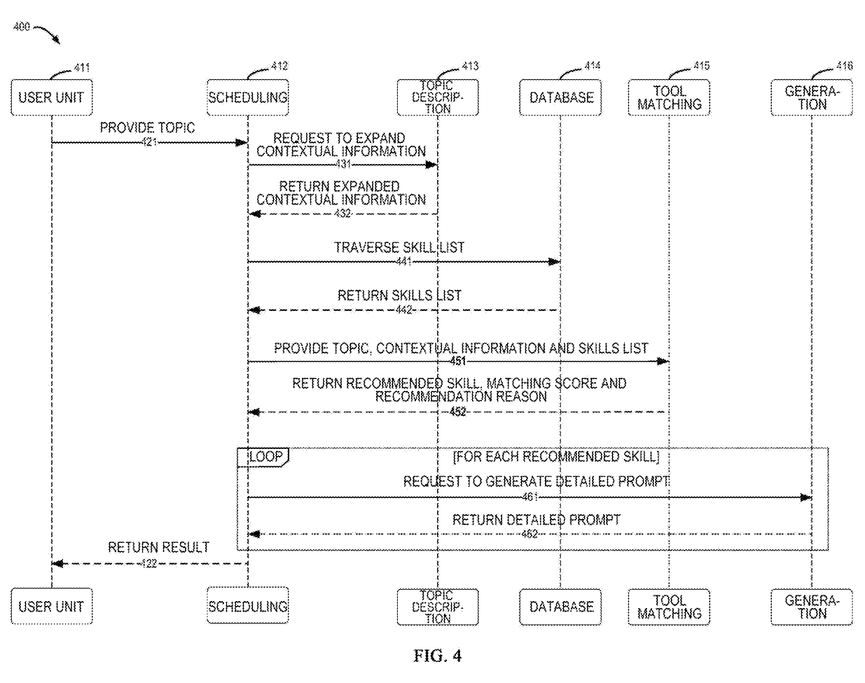

The specific process of generating the prompt information will be further described below in conjunction with FIG. 4, taking the generation of the first prompt information based on the first interactive topic as an example. FIG. 4 illustrates a timing flowchart of an example process 400 for generating a media resource according to some embodiments of the present disclosure. The process 400 may be implemented as or included in the server 130. The process 400 is described below with reference to FIG. 1.

In some embodiments, there may be a plurality of interactive topics with high interactive within the preset time period, and the server 130 may generate corresponding prompt information for each interactive topic in the set of interactive topics. As an example, such a set of interactive topics may be determined by a user unit 411. As an example, the server 130 may obtain historical interactive information based on the preset time period through the user unit 411, and then determine the set of interactive topics.

In the following, the embodiments of the present disclosure describe the process of generating the prompt information by taking as an example that the server 130 determines the first interactive topic from the set of interactive topics and generates the first prompt information corresponding to the first interactive topic based on the first interactive topic.

In some embodiments, the server 130 uses a scheduling unit 412 to coordinate and schedule the process of generating the prompt information. As an example, the server 130 may provide (421) the first interactive topic to the scheduling unit 412 through the user unit 411. Further, the server 130 may provide the first interactive topic to a topic description unit 413 through the scheduling unit 412 to generate contextual information of the first interactive topic. For example, the server 130 may request (431) to expand the contextual information of the first interactive topic to obtain the expanded contextual information of the first interactive topic returned (432) by the topic description unit 413. Therefore, the server 130 may generate the first prompt information corresponding to the first resource template based on the contextual information. As an example, such contextual information may be generated based on at least a set of search results associated with the first interactive topic.

As an example, such topic description unit 413 may support calling an appropriate generative model, which may search for specified information associated with the input topic from a specified data source, for example, to obtain a corresponding set of search results. As an example, such data source may include any appropriate data source that is publicly available or authorized to access and use, and the acquisition and use of data therein comply with corresponding laws, regulations, and related provisions. As an example, such generative model may be deployed in the server 130 for direct calling. As an example, such generative model may also be deployed in other devices and support calling through an interface.

Therefore, the server 130 may use the generative model to obtain the set of search results associated with the first interactive topic. As an example, the set of search results includes, but is not limited to, description information associated with the first interactive topic, visual description information of at least one object associated with the first interactive topic, historical interactive information for the first interactive topic, evaluation information of a search model about the first interactive topic, etc.

In some embodiments, the server 130 may obtain a set of candidate resource generation tools from a database 414. As an example, the candidate resource generation tool may also be referred to as a resource generation link, which may provide guidance information for the process of generating a resource template based on the prompt information. As an example, the server 130 traverses (441) a list (also referred to as a skill list) of the set of candidate resource generation tools (also referred to as skills) from the database 414 and obtains the list of the set of candidate resource generation tools returned (442) by the database. Therefore, the embodiments of the present disclosure may improve the accuracy of the subsequently generated first prompt information based on the set of candidate resource generation tools.

Further, the server 130 may provide (451) the first interactive topic, the contextual information, and first description information of the set of candidate resource generation tools to a tool matching unit 415 to obtain a target resource generation tool (also referred to as a recommended skill) returned (452) by the tool matching unit 415. As an example, such tool matching unit 415 may also support calling any appropriate generative model, which may determine the matching degree between a plurality of resource generation tools and the input topic, for example, and recommend one or more more suitable resource generation tools for the input topic based on the matching degree. Therefore, the tool matching unit 415 may use the generative model to determine the target resource generation tool matching the first interactive topic.

Further, the tool matching unit 415 may also return (452) the matching degree between the first interactive topic and the candidate resource generation tool and the explanation text about the matching degree to further improve the quality of the subsequently generated first prompt information.

In some embodiments, the tool matching unit 415 may return a plurality of matched resource generation tools, and the server 130 may generate respective prompt information corresponding to each of the resource generation tools. The embodiments of the present disclosure use the case where the tool matching unit 415 returns one resource generation tool (that is, the target resource generation tool) as an example for illustration. Therefore, the server 130 may use a template generation unit 416 to generate the first prompt information corresponding to the target resource generation tool.

Specifically, the server 130 may provide second description information of the target resource generation tool, the first interactive topic, and the contextual information to the template generation unit 416 to generate the first prompt information. For example, the server 130 may request (461) to generate the first prompt information (also referred to as detailed prompt) and obtain the first prompt information matching the target resource generation tool returned (462) by the template generation unit 416.

As an example, such template generation unit 416 may also support calling any appropriate generative model, which may expand the input topic based on the input topic, the contextual information, and the description information of the resource generation tool, for example, to generate the corresponding prompt information. Therefore, the tool matching unit 415 may use the generative model to generate the first prompt information.

The generative model may be used to determine the target resource generation tool matching the first interactive topic.

As an example, at least some of the template generation unit 416, the tool matching unit 415, and the topic description unit 413 may reuse an appropriate generative model to reduce resource consumption for calling the model. As an example, at least some of the template generation unit 416, the tool matching unit 415, and the topic description unit 413 may also call different generative models to improve the accuracy of the model generation result based on a more suitable generative model.

As an example, such second description information at least indicates a usage of at least one resource generation tool, examples of which include but are not limited to a generated resource type, a generated resource play method, a visual element included in the generated resource, etc. Therefore, the server 130 may return (422) the result to the user unit 411 for subsequent media resource generation. As an example, the returned result may include such first prompt information, and may also include information such as the contextual information and the first description information. As an example, such first prompt information may be configured to call the target resource generation tool to generate the corresponding media resource.

Based on this approach, the embodiments of the present disclosure can improve the quality of the generated first prompt information, thereby making the first resource template generated based on the first prompt information more accurate and of higher quality.

### Example Process

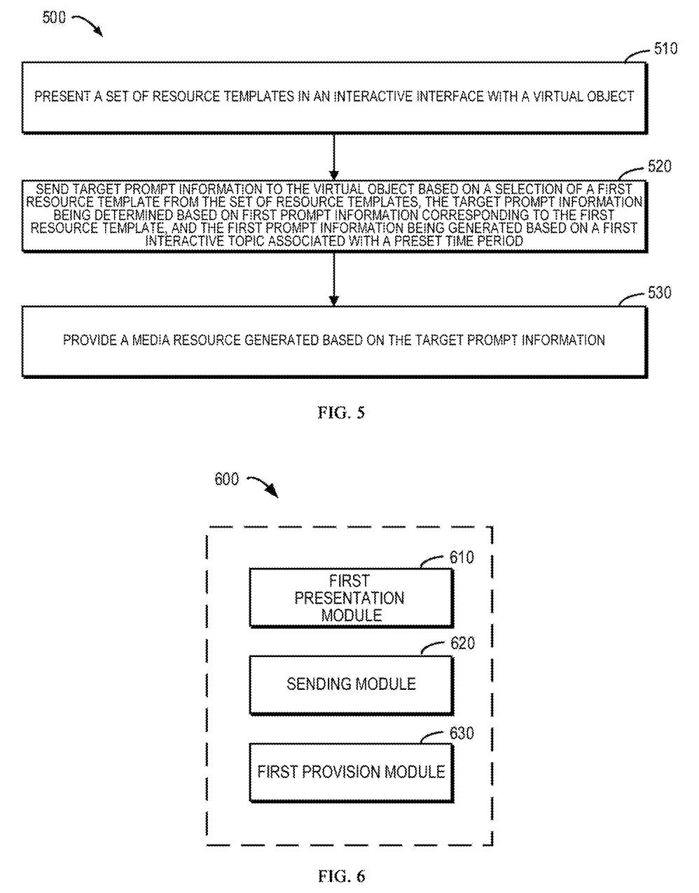

FIG. 5 illustrates a flowchart of an example process 500 for generating a media resource according to some embodiments of the present disclosure. The process 500 may be implemented at the electronic device 110. The process 500 is described below with reference to FIG. 1.

As shown in FIG. 5, at block 510, the electronic device 110 presents a set of resource templates in an interactive interface with a virtual object.

At block 520, the electronic device 110 sends second prompt information to the virtual object based on a selection of a first resource template from the set of resource templates, the second prompt information being determined based on first prompt information corresponding to the first resource template, and the first prompt information being generated based on a first interactive topic associated with a preset time period.

At block 530, the electronic device 110 provides a media resource generated based on the second prompt information.

In some embodiments, historical interactive information corresponding to the first interactive topic satisfies a preset condition.

In this way, the embodiments of the present disclosure can provide a higher-quality first interactive topic, thereby improving the quality of the first prompt information.

In some embodiments, sending the second prompt information to the virtual object based on the selection of the first resource template from the set of resource templates includes: presenting, in an input component of the interactive interface, the first prompt information corresponding to the first resource template based on the selection of the first resource template from the set of resource templates; and sending the second prompt information to the virtual object in response to receipt of a sending operation associated with the input component, the second prompt information being the first prompt information or prompt information determined by editing the first prompt information.

In this way, the embodiments of the present disclosure support the user to preview and/or edit such first prompt information, thereby further improving the quality of such first prompt information.

In some embodiments, presenting the set of resource templates in the interactive interface with the virtual object includes: presenting a set of candidate interactive topics in the interactive interface with the virtual object; and presenting the set of resource templates corresponding to the first interactive topic in response to the first interactive topic being selected from the set of candidate interactive topics.

In this way, the embodiments of the present disclosure can support media resource generation under a plurality of candidate interactive topics, thereby improving the diversity of generated media resources, and by supporting the user to select the first interactive topic, the resource templates may be filtered, thereby improving the efficiency of the user selecting a resource template.

In some embodiments, providing the media resource generated based on the second prompt information includes: presenting a chat window with the virtual object; and presenting, in the chat window, a response message generated by the virtual object based on the second prompt information, the response message including the generated media resource and description information of the media resource.

In this way, the embodiments of the present disclosure can provide the description information of the media resource in the chat window, so that the user may understand the generated media resource more conveniently.

In some embodiments, the process 500 further includes: presenting preview content of the media resource in the chat window.

In this way, the embodiments of the present disclosure can improve the efficiency of the user previewing the media resource.

In some embodiments, the process 500 further includes: presenting at least one candidate resource template in response to a switching entry in the chat window being triggered; and providing third prompt information corresponding to a second resource template to the virtual object in response to the second resource template being selected from the at least one candidate resource template.

In this way, the embodiments of the present disclosure can support quick switching of the resource template in the chat window to quickly generate a new media resource, thereby further improving the efficiency of generating the media resource.

In some embodiments, the process 500 further includes: presenting, in the interactive interface with the virtual object, reference media content corresponding to the first resource template, the reference media content being generated based on: generating a reference media resource based on the first resource template; and generating the reference media content using the reference media resource.

In this way, the embodiments of the present disclosure can support the user to preview such reference media content, so that the user may more conveniently understand the media resource supported to be generated by the resource template, and the efficiency of the user obtaining information from the interactive interface may be improved.

In some embodiments, the first prompt information includes visual description information of at least one object associated with the first interactive topic, so that the media resource generated based on the first prompt information presents a visual element corresponding to the at least one object.

In this way, the embodiments of the present disclosure can make the generated media resource richer by improving the diversity of the first prompt information, thereby improving the quality of the generated media resource. Moreover, in the embodiments of the present disclosure, by including the visual description information of the at least one object associated with the first interactive topic in the first prompt information, the correlation between the media resource and the first interactive topic may be further improved, thereby further improving the quality of the generated media resource.

In some embodiments, the first resource template is generated based on: determining the first interactive topic from a set of interactive topics, the set of interactive topics being determined based on historical interactive information within a preset time period; providing the first interactive topic to a topic description unit to generate contextual information of the first interactive topic; and generating the first prompt information corresponding to the first resource template based on the contextual information.

In this way, the embodiments of the present disclosure can more accurately describe the first interactive topic, thereby improving the quality of the generated first prompt information.

In some embodiments, the contextual information is generated based on at least a set of search results associated with the first interactive topic.

In this way, the embodiments of the present disclosure can improve the accuracy of the description of the first interactive topic.

In some embodiments, generating the first prompt information corresponding to the first resource template based on the contextual information includes: obtaining a set of candidate resource generation tools; providing the first interactive topic, the contextual information, and first description information of the set of candidate resource generation tools to a tool matching unit, to determine a target resource generation tool matching the first interactive topic from the set of candidate resource generation tools,; and generating the first prompt information corresponding to the target resource generation tool.

In this way, the embodiments of the present disclosure may match the target resource generation tool matching the first interactive topic from the set of candidate resource generation tools, and use the target resource generation tool to improve the accuracy of the first prompt information, so that such first prompt information may be used to generate a more accurate resource template with higher quality.

In some embodiments, the tool matching unit is configured to provide: a matching degree between the first interactive topic and the candidate resource generation tool; and an explanation text about the matching degree.

In this way, the embodiments of the present disclosure can further enrich the information referred to for generating the first prompt information, thereby further improving the quality of the subsequently generated first prompt information.

In some embodiments, generating the first prompt information corresponding to the target resource generation tool includes: providing second description information of the target resource generation tool, the first interactive topic, and the contextual information to a template generation unit to generate the first prompt information, the second description information at least indicating a usage of at least one resource generation tool, the first prompt information being configured to call the target resource generation tool to generate the media resource.

In this way, the embodiments of the present disclosure can generate more accurate first prompt information, thereby making the subsequently generated media resource based on the first prompt information more accurate.

In some embodiments, the media resource includes an effect resource, and the method further includes: generating media content using the effect resource, a viewing interface of the media content presenting a label associated with the first interactive topic.

In this way, the embodiments of the present disclosure may enable the user to more conveniently know the interactive topic associated with the media content when viewing the media content. Moreover, based on such a label, the user may also more conveniently browse other media content associated with the interactive topic, thereby further improving the interactive efficiency between the user and the interface.

### Example Apparatus and Device

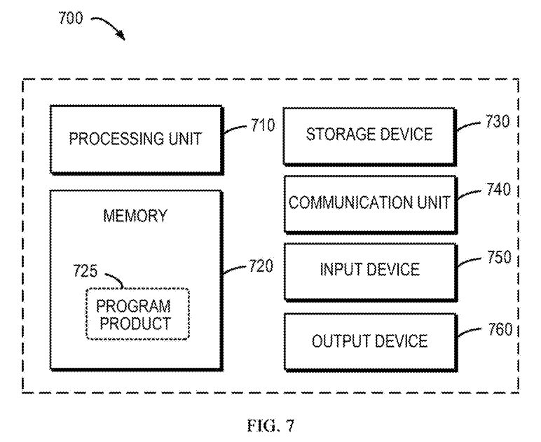

The embodiments of the present disclosure further provide a corresponding apparatus for implementing the above method or process. FIG. 6 illustrates a schematic structural block diagram of an example apparatus 600 for generating a media resource according to some embodiments of the present disclosure. The apparatus 600 may be implemented as or included in the electronic device 110 and/or the server 130. Each module/component in the apparatus 600 may be implemented by hardware, software, firmware, or any combination thereof.

As shown in FIG. 6, the apparatus 600 includes a first presentation module 610 configured to present a set of resource templates in an interactive interface with a virtual object; a sending module 620 configured to send second prompt information to the virtual object based on a selection of a first resource template from the set of resource templates, the second prompt information being determined based on first prompt information corresponding to the first resource template, and the first prompt information being generated based on a first interactive topic associated with a preset time period; and a first provision module 630 configured to provide a media resource generated based on the second prompt information.

In some embodiments, historical interactive information corresponding to the first interactive topic satisfies a preset condition.

In some embodiments, the sending module 620 is further configured to: present, in an input component of the interactive interface, the first prompt information corresponding to the first resource template based on the selection of the first resource template from the set of resource templates; and send the second prompt information to the virtual object in response to receipt of a sending operation associated with the input component, the second prompt information being the first prompt information or prompt information determined by editing the first prompt information.

In some embodiments, the first presentation module 610 is further configured to: present a set of candidate interactive topics in the interactive interface with the virtual object; and present the set of resource templates corresponding to the first interactive topic in response to the first interactive topic being selected from the set of candidate interactive topics.

In some embodiments, the first provision module 630 is further configured to: present a chat window with the virtual object; and present, in the chat window, a response message generated by the virtual object based on the second prompt information, the response message including the generated media resource and description information of the media resource.

In some embodiments, the apparatus 600 further includes a second presentation module configured to present preview content of the media resource in the chat window.

In some embodiments, the apparatus 600 further includes a second provision module configured to: present at least one candidate resource template in response to a switching entry in the chat window being triggered; and provide third prompt information corresponding to a second resource template to the virtual object in response to the second resource template being selected from the at least one candidate resource template.

In some embodiments, the apparatus 600 further includes a third presentation module configured to present, in the interactive interface with the virtual object, reference media content corresponding to the first resource template, and the apparatus 600 further includes a first generation module configured to: generate a reference media resource based on the first resource template; and generate the reference media content using the reference media resource.

In some embodiments, the first prompt information includes visual description information of at least one object associated with the first interactive topic, so that the media resource generated based on the first prompt information presents a visual element corresponding to the at least one object.

In some embodiments, the apparatus 600 further includes a second generation module configured to: determine the first interactive topic from a set of interactive topics, the set of interactive topics being determined based on historical interactive information within a preset time period; provide the first interactive topic to a topic description unit to generate contextual information of the first interactive topic; and generate the first prompt information corresponding to the first resource template based on the contextual information.

In some embodiments, the contextual information is generated based on at least a set of search results associated with the first interactive topic.

In some embodiments, the second generation module is further configured to: obtain a set of candidate resource generation tools; provide the first interactive topic, the contextual information, and first description information of the set of candidate resource generation tools to a tool matching unit to determine, from the set of candidate resource generation tools, a target resource generation tool matching the first interactive topic; and generate the first prompt information corresponding to the target resource generation tool.

In some embodiments, the tool matching unit is configured to provide: a matching degree between the first interactive topic and the candidate resource generation tool; and an explanation text about the matching degree.

In some embodiments, the second generation module is further configured to: provide second description information of the target resource generation tool, the first interactive topic, and the contextual information to a template generation unit to generate the first prompt information, the second description information at least indicating a usage of at least one resource generation tool, the first prompt information being configured to call the target resource generation tool to generate the media resource.

In some embodiments, the media resource includes an effect resource, and the apparatus 600 further includes a fourth presentation module configured to: generate media content using the effect resource, a viewing interface of the media content presenting a label associated with the first interactive topic.

The modules included in the apparatus 600 may be implemented in various ways, including software, hardware, firmware, or any combination thereof. In some embodiments, one or more units may be implemented using software and/or firmware, for example machine executable instructions stored on a storage medium. In addition to machine executable instructions or as an alternative, some or all modules in the apparatus 600 may be implemented at least partially by one or more hardware logic components. As an example, rather than a limitation, example types of hardware logic components that may be used include field programmable gate arrays (FPGAs), application specific integrated circuits (ASHCs), application specific standard products (ASSPs), system on chips (SOCs), complex programmable logic devices (CPLDs), and so on.

FIG. 7 illustrates a block diagram of an electronic device 700 in which one or more embodiments of the present disclosure may be implemented. It should be understood that the electronic device 700 shown in FIG. 7 is only exemplary, and should not constitute any limitation on the function and scope of the embodiments described herein. The electronic device 700 shown in FIG. 7 may be used to implement the electronic device 110 of FIG. 1 or the apparatus 600 of FIG. 6.

As shown in FIG. 7, the electronic device 700 is in the form of a general electronic device. The components of the electronic device 700 may include, but are not limited to, one or more processors or processing units 710, a memory 720, a storage device 730, one or more communication units 740, one or more input devices 750, and one or more output devices 760. The processing unit 710 may be an actual or virtual processor and may execute various processes based on the programs stored in the memory 720. In a multi-processor system, multiple processing units execute computer executable instructions in parallel to improve the parallel processing capability of the electronic device 700.

The electronic device 700 typically includes multiple computer storage medium. Such medium may be any available medium accessible by the electronic device 700, including but not limited to volatile and non-volatile medium, removable and non-removable medium. The memory 720 may be a volatile memory (for example, a register, cache, a random access memory (RAM)), a non-volatile memory (such as a read-only memory (ROM), an electrically erasable programmable read-only memory (EEPROM), a flash memory), or any combination thereof. The storage device 730 may be any removable or non-removable medium, and may include a machine readable medium such as a flash drive, a disk, or any other medium, which may be used to store information and/or data and may be accessed within the electronic device 700.

The electronic device 700 may further include additional removable/non-removable, volatile/non-volatile memory medium. Although not shown in FIG. 7, a disk driver for reading from or writing to a removable, non-volatile disk (such as a "floppy disk"), and an optical disk driver for reading from or writing to a removable, non-volatile optical disk may be provided. In these cases, each driver may be connected to the bus (not shown) by one or more data medium interfaces. The memory 720 may include a computer program product 725 having one or more program modules configured to perform various methods or acts of various embodiments of the present disclosure.

The communication unit 740 enables communication with other electronic devices through a communication medium. Additionally, the functions of the components of the electronic device 700 may be implemented by a single computing cluster or multiple computing machines, which may communicate through communication connections. Therefore, the electronic device 700 may use a logical connection with one or more other servers, a network personal computer (PC), or another network node to operate in a networked environment.

The input device 750 may be one or more input devices, such as a mouse, a keyboard, a tracking ball, etc. The output device 760 may be one or more output devices, such as a display, a speaker, a printer, etc. The electronic device 700 may also communicate with one or more external devices (not shown) as needed through the communication unit 740, the external devices such as a storage device, a display device, etc., communicate with one or more devices that enable a user to interact with the electronic device 700, or communicate with any devices (such as a network card, a modem, etc.) that enable the electronic device 700 to communicate with one or more other electronic devices. Such communication may be performed via input/output (I/O) interfaces (not shown).

According to an exemplary implementation of the present disclosure, there is provided a computer-readable storage medium having computer executable instructions stored thereon, where the computer executable instructions are executed by a processor to perform the method described above. According to an exemplary implementation of the present disclosure, there is further provided a computer program product tangibly stored on a non-transitory computer-readable medium and including computer executable instructions, and the computer executable instructions are executed by a processor to perform the method described above.

Various aspects of the present disclosure are described herein with reference to flowcharts and/or block diagrams of methods, apparatuses, devices, and computer program products implemented according to the present disclosure. It should be understood that each block of the flowcharts and/or block diagrams, and combinations of blocks in the flowcharts and/or block diagrams, may be implemented by computer-readable program instructions.

These computer-readable program instructions may be provided to a processing unit of a general-purpose computer, a special-purpose computer, or other programmable data processing apparatus to produce a machine, so that when these instructions are executed by the processing unit of the computer or other programmable data processing apparatus, an apparatus for implementing the functions/actions specified in one or more blocks of the flowcharts and/or block diagrams is produced. These computer-readable program instructions may also be stored in a computer-readable storage medium, these instructions make the computer, the programmable data processing apparatus, and/or other devices work in a specific way, so that the computer-readable medium storing the instructions includes a manufactured product, which includes instructions for implementing various aspects of the functions/actions specified in one or more blocks of the flowcharts and/or block diagrams.

The computer-readable program instructions may be loaded onto a computer, another programmable data processing apparatus, or other devices, so that a series of operation steps are performed on the computer, the other programmable data processing apparatus, or the other devices to produce a computer-implemented process, so that the instructions executed on the computer, the other programmable data processing apparatus, or the other devices implement the functions/actions specified in one or more blocks of the flowcharts and/or block diagrams.

The flowcharts and block diagrams in the drawings illustrate the architecture, functionality, and operation of possible implementations of systems, methods and computer program products according to various implementations of the present disclosure. In this regard, each block in the flowchart or block diagrams may represent a module, program segment, or portion of instructions, which includes one or more executable instructions for implementing the specified logical function(s). In some alternative implementations, the functions noted in the block may occur in an order different from that noted in the drawings. For example, two blocks shown in succession may, in fact, be executed substantially concurrently, or the blocks may sometimes be executed in the reverse order, depending upon the functionality involved. It will also be noted that each block of the block diagrams and/or flowchart, and combinations of blocks in the block diagrams and/or flowchart, may be implemented by special purpose hardware-based systems that perform the specified functions or acts, or combinations of special purpose hardware and computer instructions.

Various implementations of the present disclosure have been described above, and the foregoing description is exemplary, non-exhaustive, and not limited to the disclosed implementations. Many modifications and variations will be apparent to those of ordinary skill in the art without departing from the scope and spirit of the illustrated implementations. The choice of terms used herein is intended to best explain the principles of the implementations, the practical application or improvement over the technology in the market, or to enable other ordinary skilled persons in the art to understand the various implementations disclosed herein.

1. A method of generating a media resource, comprising:
presenting a set of resource templates in an interactive interface with a virtual object;
sending second prompt information to the virtual object based on a selection of a first resource template from the set of resource templates, the second prompt information being determined based on first prompt information corresponding to the first resource template, and the first prompt information being generated based on a first interactive topic associated with a preset time period; and
providing a media resource generated based on the second prompt information.

2. The method of claim 1, wherein historical interactive information corresponding to the first interactive topic satisfies a preset condition.

3. The method of claim 1, wherein sending the second prompt information to the virtual object based on the selection of the first resource template from the set of resource templates comprises:
presenting, in an input component of the interactive interface, the first prompt information corresponding to the first resource template based on the selection of the first resource template from the set of resource templates; and
sending the second prompt information to the virtual object in response to receipt of a sending operation associated with the input component, the second prompt information being the first prompt information or prompt information determined by editing the first prompt information.

4. The method of claim 1, wherein presenting the set of resource templates in the interactive interface with the virtual object comprises:
presenting a set of candidate interactive topics in the interactive interface with the virtual object; and
presenting the set of resource templates corresponding to the first interactive topic in response to the first interactive topic being selected from the set of candidate interactive topics.

5. The method of claim 1, wherein providing the media resource generated based on the second prompt information comprises:
presenting a chat window with the virtual object; and
presenting, in the chat window, a response message generated by the virtual object based on the second prompt information, the response message comprising the generated media resource and description information of the media resource.

6. The method of claim 5, further comprising:
presenting preview content of the media resource in the chat window.

7. The method of claim 5, further comprising:
presenting at least one candidate resource template in response to a switching entry in the chat window being triggered; and
providing, in response to a second resource template being selected from the at least one candidate resource template, third prompt information corresponding to the second resource template to the virtual object.

8. The method of claim 1, further comprising:
presenting, in the interactive interface with the virtual object, reference media content corresponding to the first resource template, the reference media content being generated based on:
generating a reference media resource based on the first resource template; and
generating the reference media content using the reference media resource.

9. The method of claim 1, wherein the first prompt information comprises visual description information of at least one object associated with the first interactive topic, such that the media resource generated based on the first prompt information presents a visual element corresponding to the at least one object.

10. The method of claim 1, wherein the first resource template is generated based on:
determining the first interactive topic from a set of interactive topics, the set of interactive topics being determined based on historical interactive information within a preset time period;
providing the first interactive topic to a topic description unit to generate contextual information of the first interactive topic; and
generating the first prompt information corresponding to the first resource template based on the contextual information.

11. The method of claim 10, wherein the contextual information is generated at least based on a set of search results associated with the first interactive topic.

12. The method of claim 11, wherein generating the first prompt information corresponding to the first resource template based on the contextual information comprises:
obtaining a set of candidate resource generation tools;
providing, to a tool matching unit, the first interactive topic, the contextual information and first description information of the set of candidate resource generation tools, to determine a target resource generation tool matching the first interactive topic from the set of candidate resource generation tools; and
generating the first prompt information corresponding to the target resource generation tool.

13. The method of claim 12, wherein the tool matching unit is configured to provide:
a matching degree between the first interactive topic and a candidate resource generation tool; and
an explanation text about the matching degree.

14. The method of claim 12, wherein generating the first prompt information corresponding to the target resource generation tool comprises:
providing, to a template generation unit, second description information of the target resource generation tool, the first interactive topic and the contextual information, to generate the first prompt information, the second description information at least indicating a usage of at least one resource generation tool, and the first prompt information being configured to call the target resource generation tool to generate the media resource.

15. The method of claim 1, wherein the media resource comprises an effect resource, and the method further comprises:
generating media content using the effect resource, wherein a viewing interface of the media content presents a label associated with the first interactive topic.

16. An electronic device, comprising:
at least one processor; and
at least one memory coupled to the at least one processor and storing instructions for execution by the at least one processor, the instructions, when executed by the at least one processor, causing the electronic device to perform operations comprising:
presenting a set of resource templates in an interactive interface with a virtual object;
sending second prompt information to the virtual object based on a selection of a first resource template from the set of resource templates, the second prompt information being determined based on first prompt information corresponding to the first resource template, and the first prompt information being generated based on a first interactive topic associated with a preset time period; and
providing a media resource generated based on the second prompt information.

17. The electronic device of claim 16, wherein historical interactive information corresponding to the first interactive topic satisfies a preset condition.

18. The electronic device of claim 16, wherein sending the second prompt information to the virtual object based on the selection of the first resource template from the set of resource templates comprises:
presenting, in an input component of the interactive interface, the first prompt information corresponding to the first resource template based on the selection of the first resource template from the set of resource templates; and
sending the second prompt information to the virtual object in response to receipt of sending associated with the input component, the second prompt information being the first prompt information or prompt information determined by editing the first prompt information.

19. The electronic device of claim 16, wherein presenting the set of resource templates in the interactive interface with the virtual object comprises:
presenting a set of candidate interactive topics in the interactive interface with the virtual object; and
presenting the set of resource templates corresponding to the first interactive topic in response to the first interactive topic being selected from the set of candidate interactive topics.

20. A non-transitory computer-readable storage medium having a computer program stored thereon, which, when executed by a processor, performs operations comprising:
presenting a set of resource templates in an interactive interface with a virtual object;
sending second prompt information to the virtual object based on a selection of a first resource template from the set of resource templates, the second prompt information being determined based on first prompt information corresponding to the first resource template, and the first prompt information being generated based on a first interactive topic associated with a preset time period; and
providing a media resource generated based on the second prompt information.
